(19) United States
(12) Patent Application Publication
(10) Pub. No.: US 2016/0033081 A1
(43) Pub. Date: Feb. 4, 2016

(54) GAS STORAGE MODULES, APPARATUS, SYSTEMS AND METHODS UTILIZING ADSORBENT MATERIALS

(71) Applicant: RESEARCH TRIANGLE INSTITUTE, Research Triangle Park, NC (US)

(72) Inventors: Luke Coleman, Durham, NC (US); Marty Lail, Raleigh, NC (US); Jak Tanthana, Durham, NC (US); Thomas Nelson, Houston, TX (US)

(21) Appl. No.: 14/775,060

(22) PCT Filed: Mar. 14, 2014
(86) PCT No.: PCT/US2014/027840

§ 371 Date: Sep. 11, 2015

Related U.S. Application Data
(60) Provisional application No. 61/784,893, filed on Mar. 14, 2013.

(51) Int. Cl. F17C 11/00

(52) U.S. Cl. CPC F17C 11/007; F17C 2209/2109

(57) ABSTRACT

A gas storage module includes a two-dimensional body and a heat exchanging structure. The body includes a packed adsorbent having a composition and porosity effective for adsorbing a gas such as methane. The body may be self-supporting or encapsulated in a porous support structure. The body includes gas flow channels. Several modules may be stacked together and provided in a storage tank.

### RELATED APPLICATIONS

This application claims the benefit of U.S. Provisional Patent Application Ser. No. 61/784,893, filed Mar. 14, 2013, titled “GAS STORAGE MODULES, APPARATUS, SYSTEMS AND METHODS UTILIZING ADSORBENT MATERIALS,” the content of which is incorporated by reference herein in its entirety.

### TECHNICAL FIELD

The present invention relates generally to gas storage by adsorption.

### BACKGROUND

A gas may be stored in various forms for later use as an energy source. For example, a gas may be compressed to a high pressure in a tank or cryogenically cooled to a condensed liquid. These storage methods can densify the gas and thereby increase its inherent volumetric energy density (VED). However, these storage methods have disadvantages. The storage of compressed gas requires the use of a heavy, expensive tank and pumping system, and high-pressure gas storage may pose a safety concern in certain operating environments. The storage of gas compounds in a condensed liquid state requires the use of costly, bulky and complex equipment.

A gas may alternatively be stored by reversible adsorption on a porous material. Of current interest is developing adsorbent-based gas storage systems that enable densification at moderate pressures and near ambient temperatures, while still achieving a VED comparable to or better than that achievable by compression or liquefaction. Due to a lower operating pressure in comparison to a compressed gas tank, the walls of a tank employed for adsorbed gas may be made thinner, thereby reducing tank weight and cost. In addition, adsorbed gas tanks may have a variety of geometries that enable them to conform to available space, as compared to the cylindrical and spherical geometries to which compressed gas tanks and condensed gas tanks are typically restricted. This flexibility may allow adsorbed gas tanks to be installed, for example, on or in a vehicle without compromising storage or passenger space, and may facilitate the integration of adsorbed gas tanks with portable/mobile devices. In addition, adsorbed gas does not require complex and expensive compression or liquefaction equipment for storage and distribution.

Unfortunately, the progress of adsorbed gas technology has thus far been hindered by the low VEDs of currently known adsorbents. The VED of adsorbed gas systems is impacted by several factors, including the gravimetric gas loading capacity of the adsorbent (g_{gas}/g_{sorbent}), the bulk density of the adsorbent (g_{sorbent}/mL_{sorbent}), and the specific packing volume of the adsorbent in the tank (mL_{sorbent}/mLₜₐₙₖ). Specific packing volume is a measure of the amount of adsorbent in the tank, and accounts for the reduction in available volume due to the process-related internals often employed (e.g., heat transfer internals, gas distribution, measurement devices, sorbent protection devices, etc.). To date, research directed to adsorbed gas storage has been mainly geared towards developing materials with higher gravimetric gas loadings with little emphasis on addressing the low bulk density of high surface materials, which typically range from 0.25 to 0.4 g_{sorbent}/mL_{sorbent}, or developing strategies for achieving high specific packing volumes. Although improving the gas loading of the adsorbent is important for improving the VED, development of adsorbent densification methods and packing strategies that increase the mass of adsorbent in the tank are also needed for increasing the VED of adsorbed gas systems to the point where they exceed the VEDs of conventional methods such as compression and liquefaction.

In addition to the need for improving VED, improvement in thermal management of the adsorbed gas tank is needed for efficient and reliable operation as the system operates essentially as a condenser during charging (adsorption) and an evaporator during discharging (desorption). During charging of the tank, the gas is condensed on the adsorbent surface releasing the heat of adsorption, which is greater than the heat of vaporization of the gas. The tank temperature rises during gas uptake which ultimately leads to a reduction in the gas storage capacity, and hence a reduction in the VED, because adsorption is an exothermic, self-extinguishing process. To achieve the desired gas loading, the heat generated must be removed during the charging process to mitigate under-loading the tank. In some applications, inadequate heat management during charging has been shown to reduce storage capacity by greater than 25%. Similarly, but to a lesser extent, gas discharge from the adsorbent is an endothermic process that consumes heat from the surroundings causing the temperature of the tank to decrease, which can lead to a reduction in the desorption rate. The reduction in desorption rate may adversely affect the performance of a device whose operation depends on the supply rate of the gas, such as for example a vehicle's engine. Thus, to meet the gas availability demand of a power consuming device, the adsorbed gas tank must be heated at appropriate times.

Several thermal management and gas distribution strategies have been evaluated for mitigating the adverse thermal effects associated with gas adsorption and desorption on tank performance. Much of the previous work has focused on incorporating heat exchanger designs into the storage vessel to provide heating and cooling to the packed bed of sorbent during gas charging/discharging. Although the storage efficiency can be improved by stabilizing the temperature during charging and discharging via controlling the adsorbent bed temperature, the presence of heat transfer internals within the storage vessel can dramatically decrease the available volume for adsorbent in the tank. Moreover, existing heat transfer systems provide excessively long distances between the heat source and the heat sink, particularly when considering that the typical adsorbent is a highly porous, low thermal conductivity solid. Thus, temperature control during charging and discharging has not been optimized and further improvements are needed.

In addition, existing adsorbed gas systems do not provide effective distribution of the gas to and from the adsorbent, and thus do not provide adequate charging and discharging rates. Existing systems require excessively long distances for adsorbate to migrate or flow before being discharged from the tank, or for incoming gas to flow from the tank's entrance to the farthest adsorption site. Also, an excessive pressure drop across the sorbent bed can have an adverse effect on charge/discharge rates and useful working capacity.

In addition, existing adsorbed gas fuel tank designs do not sufficiently address the problem of attrition and settling of particulate adsorbents. Particles tend to vibrate and break apart, resulting in stratification of adsorbent particles and redistribution of the bed. Moreover, particles liberated from the bed may be entrained during discharge, resulting in the blocking of flow channels, tubes, pressure control valves, measurement devices, etc.

The above-noted challenges apply to the storage of, for example, gases utilized (or under investigation for use) as alternative fuels. One specific example is natural gas (NG), which is conventionally stored by compression (compressed natural gas or CNG) or condensation (liquid natural gas or LNG). VED is a factor of particular interest in the context of on-board storage of a fuel in vehicular applications, as VED can be correlated to travel distance per unit of storage tank volume and affects the size of the storage tank required for a particular application. NG has a low inherent VED (0.0364 MJ/L) due to its being a gas at ambient conditions. By comparison, CNG has a VED of 9.2 MJ/L (at 250 bar) and LNG has a VED of 22.2 MJ/L (at −161.5° C.). While compression or condensation of NG thus improves VED, the VEDs of CNG and LNG are only 27% and 64%, respectively, of the VED of gasoline (34.2 MJ/L). For NG-powered vehicles, this translates into large fuel tank volumes and/or reduced travel distances. Moreover, densifying NG to compressed or condensed form carries the same disadvantages as noted above for gases in general.

Currently known adsorbents of methane (CH₄, the predominant component of NG) include activated carbons and structured microporous materials such as metal organic frameworks and porous polymer networks. Adsorbed natural gas (ANG) systems employing such adsorbents have yielded less than optimal VEDs, for example less than about 7 MJ/L at 35 bar, which is lower than the VED of CNG at 250 bar. Improvements are needed for increasing the VED of ANG systems to the point where they exceed CNG VED and possibly rival the VED of gasoline tanks

In view of the foregoing, there continues to be a need for improved apparatus and methods for gas storage by adsorption.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one embodiment, a gas storage module includes: a two-dimensional body comprising a first surface, an opposing second surface, a side wall between the first surface and the second surface, and a plurality of channels communicating with the side wall and extending from the side wall through or along the body; and a heat exchanging structure extending along a plane co-planar with the first surface and the second surface, wherein the body comprises a packed mixture of an adsorbent and a binder, the adsorbent comprising a plurality of particles having a composition and porosity effective for adsorbing a gas, and the binder having a composition effective for binding the particles together.

According to another embodiment, a gas storage apparatus includes a plurality of gas storage modules stacked together such that the first surface or the second surface of each gas storage module faces the first surface or second surface of at least one other adjacent gas storage module.

According to another embodiment, a method for fabricating a gas storage module includes: mixing an adsorbent and a binder, wherein the adsorbent comprises a plurality of particles having a composition and porosity effective for adsorbing a gas, and the binder having a composition effective for binding the particles together; forming a two-dimensional body from the mixture such that the body comprises a first surface, an opposing second surface, a side wall between the first surface and the second surface, and a plurality of channels communicating with the side wall and extending from the side wall through or along the body, wherein forming comprises packing the mixture to a desired density of the adsorbent in the body; and positioning a heat exchanging structure relative to the body such that the heat exchanging structure extends along a plane co-planar with the first surface and the second surface.

According to another embodiment, a method for fabricating a gas storage apparatus includes: stacking together a plurality of gas storage modules, such that the first surface or the second surface of each gas storage module faces the first surface or second surface of at least one other adjacent gas storage module.

According to another embodiment, a method for storing gas includes: flowing the gas through a plurality of channels extending through or along a two-dimensional body comprising a plurality of adsorbent particles, wherein the gas diffuses into the body from the channels and is adsorbed in pores of the particles, and the adsorption generates heat; and while flowing the gas, transferring the heat from the adsorbent particles to a heat exchanging structure extending along a plane co-planar with a first surface and an opposing second surface of the body.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a perspective view an example of a gas storage module according to some embodiments.

FIG. 2 is a plan view of the gas storage module illustrated in FIG. 1.

FIG. 3 is a side view of the gas storage module illustrated in FIG. 1.

FIG. 4 is a perspective view of an example of a gas storage apparatus according to some embodiments.

FIG. 5 is an elevation view of the gas storage apparatus illustrated in FIG. 4.

FIG. 6 is an elevation view of an example of a gas storage apparatus according to other embodiments.

FIG. 7 is a perspective view an example of a gas storage module according to other embodiments.

FIG. 8 is a plan view of the gas storage module illustrated in FIG. 7.

FIG. 9 is a side view of the gas storage module illustrated in FIG. 7.

FIG. 10 is a perspective view of an example of a gas storage apparatus according to other embodiments.

FIG. 11 is a schematic view of an example of a gas storage system according to some embodiments.

### DETAILED DESCRIPTION

In one aspect of the present disclosure, a gas storage module is provided. The structure of the gas storage module is based on a packing (or packed bed) of porous adsorbent material (e.g., particles or powders). The gas storage module may be configured for adsorbing one or more types of gases. The gas may thereafter be desorbed from the gas storage module and distributed for use. Examples of gases that may be adsorbed and thereafter desorbed include, but are not limited to, natural gas (particularly the methane fraction thereof); other gaseous hydrocarbons such as those typically employed as fuels for automotive, naval, aircraft, space, and portable device applications (e.g., propane); hydrogen; carbon dioxide; ammonia; and gaseous fluorocarbon-based compounds such as may be employed as refrigerants or phase-changing fluids. The gas storage module may be configured to be arranged (e.g., stacked) with other gas storage modules in a manner that minimizes overall form factor and volume while providing high-capacity gas storage. The gas storage module may include integrated features that provide paths for transporting a gas to and from the adsorption sites, and paths for transporting a heat transfer medium through the bulk of the gas storage module and/or across outside surfaces of the gas storage module.

The packing of porous, adsorbent particles (“adsorbent” or “adsorbent material”) forms the main body of the gas storage module. In some embodiments, the packing is a mixture of adsorbents and binding agents (binders), or a mixture of adsorbent, binders and additives. The particles are highly porous so as to present a very large surface area for adsorption activity. The adsorbent may have any composition and porosity effective for adsorbing a desired type of gas, such as those given by example above. Examples of adsorbents include, but are not limited to, activated carbon; various metal organic frameworks (MOFs) such as, for example, MOF-5, PCN-14, etc.; zeolites, porous polymers (including microporous coordinated polymers) such as, for example, PPN-3, PPN-4, PPN-5, etc.; molsieves; and chemical adsorbents. Adsorption may be a bulk property of the adsorbent, or may be the result of functionalizing or capping the porous surface of a particle with a component (e.g., functional group, moiety, ion, radical, molecule, etc.) that provides or enhances the host particle's adsorptive properties (e.g., amines supported on a porous particle). In some embodiments, the packing may include a combination or two or more different types of adsorbent particles, provided that the different particles are capable of being formed into a stable packing.

In some embodiments, the packing includes one or more types of additives in addition to the adsorbents and binders. Generally, an additive is a component added to the packing to impart or enhance an attribute, function or property of the packing Examples of additives include, but are not limited to, plasticizers, strength enhancers, porosity enhancers (e.g., methyl cellulose), and thermal conductivity enhancers. It will be noted that certain binders may also provide an additive role such those just noted. Moreover, certain binders and additives may exhibit, as an ancillary property, adsorptive activity for the gas being stored.

In a given packing that forms the body of the gas storage module, generally no specific limitation is placed on properties such as particle size (e.g., average diameter), the degree of polydispersity in particle size, particle porosity, or the interstitial spacing between neighboring particles (void size), so long as such properties render the gas storage module suitable for the uses contemplated by the present disclosure. Such properties may depend in part on factors such as particle composition, the process utilized to synthesize or fabricate the particle, and the process utilized to form the packed body. In some embodiments, the particle size may range from micrometer-scale to centimeter-scale. Generally, the body may be fabricated by any method suitable for forming a packed adsorbent bed exhibiting properties desirable for a particular application. Depending on the embodiment, the body may be self-supporting or may be encapsulated by a support structure, examples of which are described below.

In some embodiments, the adsorbent has a gravimetric loading capacity for methane of 0.2 or greater g_{CH4}/gₛ. In some embodiments, the adsorbent has a bulk density ranging from 0.2 to 1.5 gₛ/mLₛ.

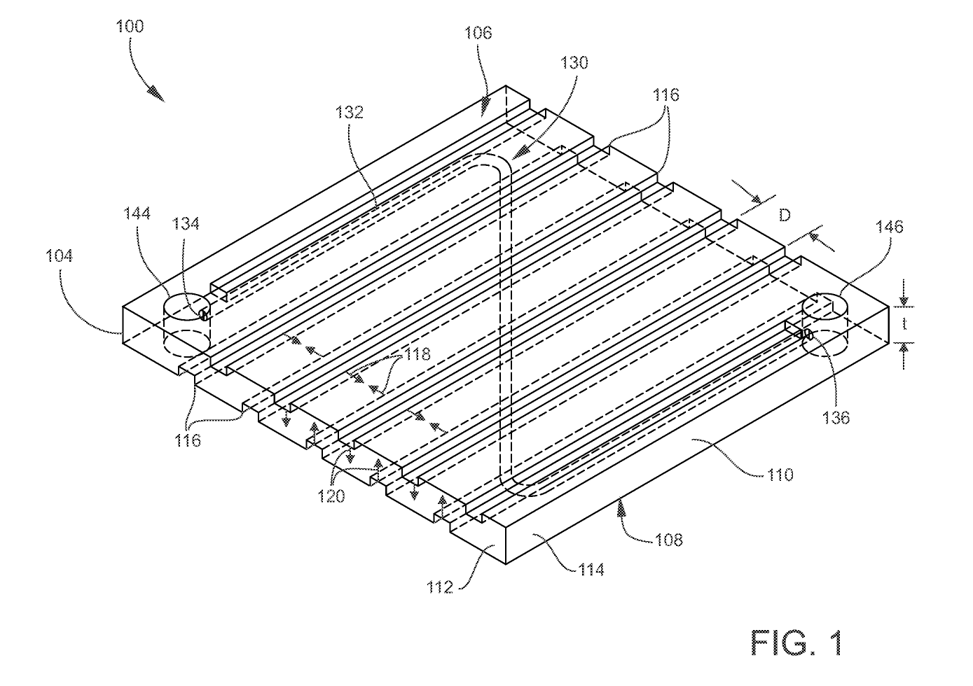

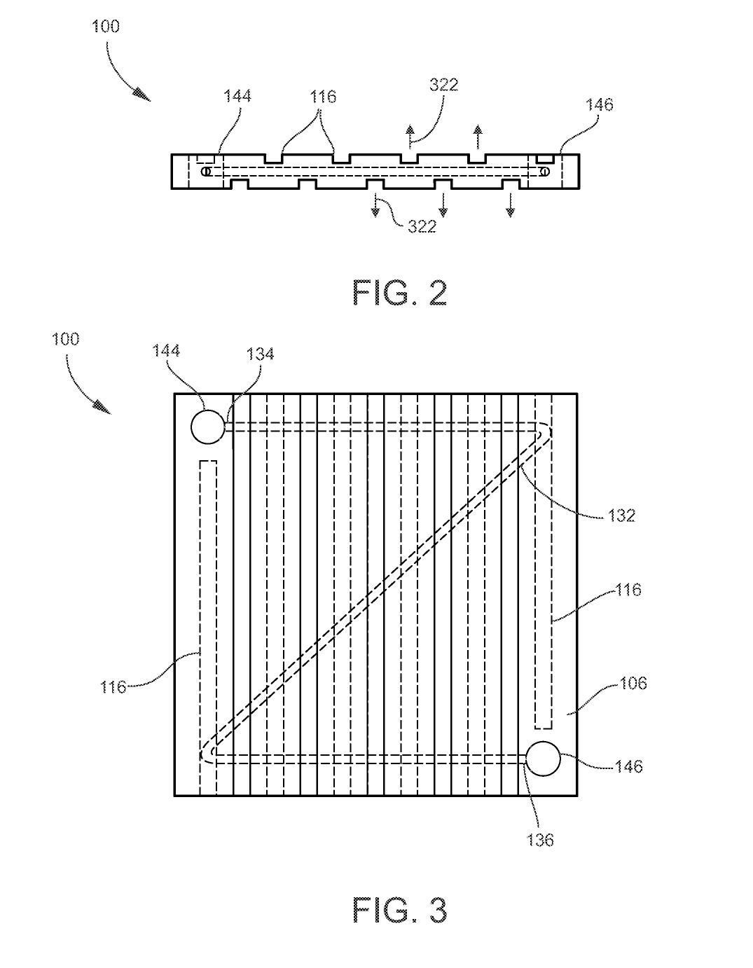

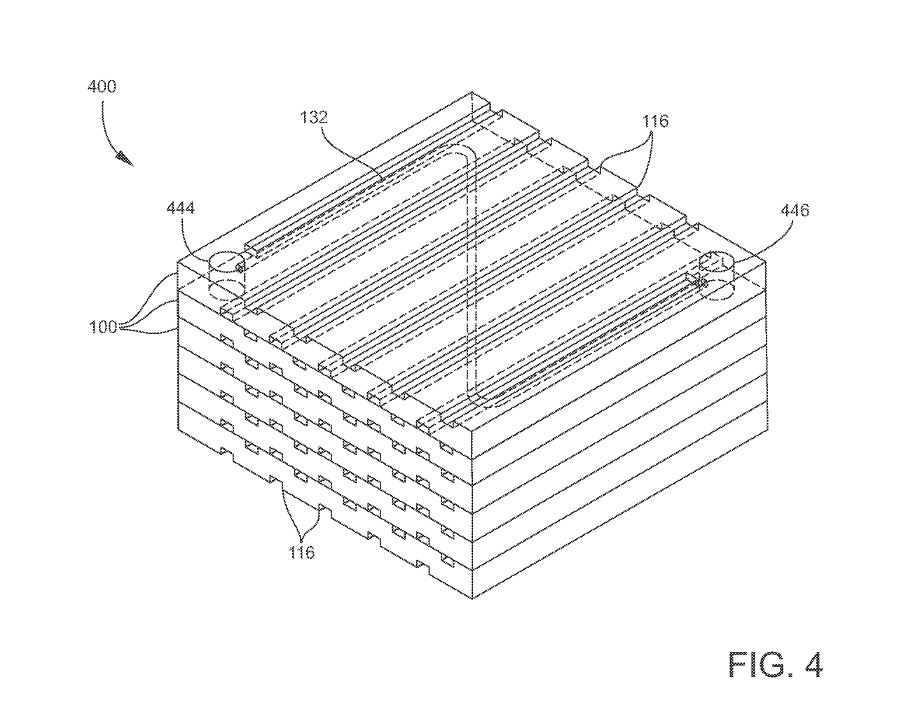

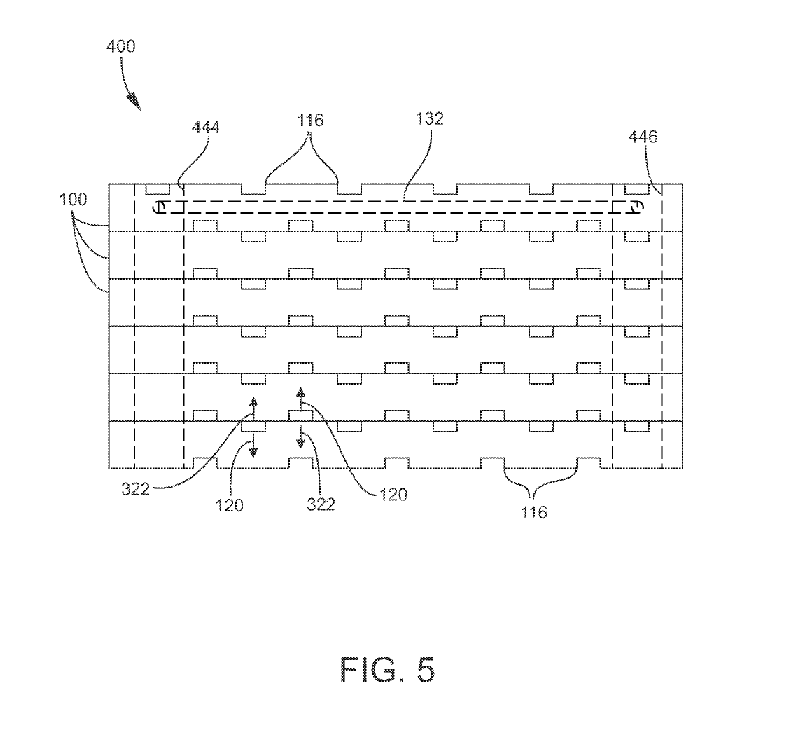

FIGS. 1-3 illustrates an example of a gas storage module 100 according to some embodiments. Specifically, FIG. 1 is a perspective view, FIG. 2 is a plan view, and FIG. 3 is a side view of the gas storage module 100. The gas storage module 100 may be included in a gas storage apparatus or system as described below. The gas storage module 100 may generally include a two-dimensional or planar body 104 (or plate, panel, core, etc.). The body 104 includes a first surface 106, an opposing second surface 108, and a side wall 110 between the first surface 106 and second surface 108. In the present context, the term “side wall” refers generally to the wall(s) defining the entire perimeter of the body 104. Depending on how many sides the body 104 has (four in the present example), the side wall 110 may comprise a number of side wall sections (e.g., sections 112 and 114) corresponding to the number of sides. In the present context, the term “two-dimensional” or “planar” indicates that the surface area of the first surface 106 (or second surface 108) is appreciably larger than the surface area of the side wall section 112, 114 located at any one side of the body 104—or, at least, that the length (or width) of at least one side of the first surface 106 (or second surface 108) is appreciably larger than a thickness t (or height) of the side wall 110. Stated in another way, the cross-section of the gas storage module 100 (in the plane orthogonal to the direction of thickness t) is the predominant dimensional feature of the gas storage module 100. As an example, in the illustrated embodiment the body 104 is generally plate-shaped. The low-profile geometry provides a large surface area for adsorbing/desorbing gas and for transferring heat. The low-profile geometry also facilitates stacking several gas storage modules together, as described below in conjunction with FIGS. 4 and 5.

In the example illustrated in FIG. 1, the gas storage module 100 has a generally rectilinear cross-section. More generally, however, the gas storage module 100 may have any cross-section desired for a given implementation. Examples include, but are not limited to, other polygonal cross-sections and round cross-sections (e.g., circular, elliptical, oval, kidney, etc.). Moreover, the cross-section need not be symmetrical relative to all axes in the plane of the first surface 106 or second surface 108. Thus, for example, the cross-section may be semicircular, semi-elliptical, a combination of two or more different polygonal cross-sections, a combination of two or more different round cross-sections, or a combination of polygonal and round cross-sections. As another example, at least one side of the gas storage module 100 may be curved to conform in the inside surface of a round (e.g., cylindrical or spherical) tank. As a further example, the cross-section may feature one or more lobes, i.e., may be lobed or kidney-shaped, which is a geometry employed in certain gas storage tanks. Thus, a stack of gas storage modules having a lobed cross-section may be provided in a tank of like cross-section.

The body 104 is formed as a packing of porous, adsorbent particles as described above. Generally, the body may be fabricated by any method suitable for forming a robust, stable packing capable of maintaining its shape over a service life considered acceptable by the relevant industry. A stable packing may be one which exhibits a low level of friability, particle attrition, settling, segregation, and frangibility over repeated iterations of adsorption and desorption and thermal cycling throughout the service life, and which has an acceptable level of insensitivity to vibrations and other forces normally expected to be encountered by gas storage tanks. The forming method may entail, for example, compacting, pressing, heat pressing, extruding or chemically binding the particles according to any technique now known or later developed. As one example, the particles may be loaded in a vessel and a plate may be forcibly pressed against the particles. In another example, the particles may be loaded between two molds, and force may be applied by one or both molds against the particles. The starting particles or powders may be commercially acquired or formed by, for example, spray drying. In some embodiments, one or more different types of binders may be included in the packing A binder is generally any component effective for stably binding the adsorbent particles together in conjunction with the forming process. Examples of binders include, but are not limited to, minerals such as clays, ceramics such as alumina and silica, polymers such as polyvinyl alcohols and polyvinylbutyral. In other embodiments, the adsorbent particles may be cohesive enough to form a stable packing without the use of binders. In some embodiments, the packing may further include additives as described above.

In the embodiment illustrated in FIG. 1, the body 104 is a self-supporting body. That is, the adsorbent particles (or mixture of adsorbent particles and binders and/or additives) are tightly packed together such that, after forming the packing, the resulting body 104 is capable of maintaining its form without the aid of a frame or other supporting structure. The method implemented to form the packing densifies the adsorbent, thereby increasing the specific packing volume of the resulting body by eliminating or at least significantly reducing intraparticle voids. Moreover, the body 104 is sufficiently strong and robust that engineering features (e.g., channels, bores, etc.) may be formed or provided on or in the body 104 during the packing process. As an example, external features may be formed by utilizing complementarily shaped molds that are pressed against the particles during packing. As another example, internal features may be provided by loading the particles around the internal features before packing such that the internal features are embedded in the loose particle mass. During pressing, a stable particulate packing is formed with the internal features included. Hollow internal features such as tubes may be plugged at their ends prior to packing to prevent ingress of particles, and the plugs may be removed after completion of the packing process.

In the embodiment illustrated in FIG. 1, the body 104 includes a plurality of gas flow channels 116 communicating with the side wall 110. The channels 116 provide flow paths for transporting gas to the body 104 during the adsorption process and from the body 104 during the desorption process. For this purpose, each channel 116 (i.e., at least one end of the channel 116) may communicate with at least one side wall section. The opposite ends of one or more channels 116 may communicate with other side wall sections. For example, in FIG. 1 some of the channels 116 extend between two opposing sides of the body 104. In some embodiments, one or more channels 116 may be bent or curved, or straight but at an angle to the sides, and extend between two adjoining sides of the body 104. The channels 116 are configured to expose the gas to be adsorbed to large surface areas of the body, thereby promoting the adsorption process. The channels 116 may also be configured to assist in balancing or equalizing the gas pressure inside the tank, which may improve the rate of gas uptake (or discharge) and distribute the heat load uniformly. The channels 116 may have any configuration or pattern suitable for these purposes. In the present embodiment, the channels 116 are straight and parallel. In other embodiments, one or more channels may be bent or curved as noted above, and one or more channels may be non-parallel to other channels. In other embodiments, the channels may follow a path that turns one or more times. For example, a channel may be configured as a jagged line or wave (e.g., square wave, sawtooth wave, sinusoidal wave, etc.). Also in other embodiments, one or more channels may intersect other channels. In further examples, the channels may be arranged in the form of a fishbone (e.g., herringbone) or cross-hatching.

In the present embodiment, the channels 116 have an open-cell configuration that allows the free flow of gas. The channels 116 are disposed on the outside of the body 104 and thus are open channels with the open side facing away from the body 104. The channels 116 may extend along the first surface 106, the second surface 108, or both the first surface 106 and the second surface 108. The cross-sectional area (in the plane of the thickness of the body 104) of the channels 116 may be polygonal (e.g., rectilinear in the illustrated example) or may be rounded. In the present embodiment, the channels 116 are formed in or defined by the packing of the body 104. The channels 116 may thus be considered as grooves in the body 104, or alternatively as spaces between raised portions of the body 104. When provided on both the first surface 106 and second surface 108, the channels 116 in some embodiments may be arranged in an alternating or offset pattern as illustrated in FIG. 1.

In operation, during adsorption a gas is fed to the ends of the channels 116 that are open at the side wall 110. If both ends of a given channel are open to the side wall 110, as in the case of some of the channels 116 shown in FIG. 1, the gas may be fed to either one end or both ends of that channel. Upon entry into the channels 116, the gas flows along the length of the channels 116 and diffuses into the bulk of the body 104. As the gas diffuses, individual gas molecules become adsorbed on the porous surfaces of the adsorbent particles. The direction of gas diffusion may generally be unidirectional. Thus, from a given channel the gas may diffuse in transverse directions along the cross-sectional plane, such as opposite directions leading away from the longitudinal axis of the channel as represented by arrows 118 in FIG. 1. The gas may also diffuse in directions orthogonal to the cross-sectional plane and parallel with the direction of the module's thickness (vertical directions from the perspective of FIG. 1), such as the directions represented by other arrows 120 in FIG. 1. When multiple gas storage modules 100 are stacked closely together (FIGS. 4 and 5), the gas flowing in the channels of one gas storage module may diffuse into the other gas storage module(s) adjacent to the first surface 106 and/or second surface 108, such as in directions represented by arrows 322 in FIG. 2 which are opposite to the corresponding internally directed arrows 120 in FIG. 1 (see also FIG. 5).

During desorption, the gas may follow diffusion paths from the particle packing back into the channels 116 along directions generally opposite to those just described and shown in FIGS. 1 and 2.

The gas storage module 100 may thus be configured for providing multiple gas diffusion paths from each channel 116 in a manner that utilizes the entire volume of the particle packing comprising the gas storage module 100, thereby maximizing the number of available adsorption sites. The gas storage module 100 may be configured for optimizing the adsorption/desorption processes by minimizing gas diffusion lengths between the channels 116 and adsorption sites. In some embodiments, the spacing between adjacent channels 116 on the first surface 106 and between adjacent channels on the second surface 108 may be minimized relative to the thickness of the gas storage module 100 to minimize gas diffusion length. For example, in the embodiment illustrated in FIG. 1, each channel 116 is separated from an adjacent channel 116 by a separation distance D. The maximum gas diffusion length in the transverse direction may be approximated to be one-half of the separation distance D. The maximum gas diffusion length in this dimension may thus be represented approximately by the arrows 118. In some embodiments, the separation distance D is selected such that the maximum diffusion length (one-half of the separation distance D) is equal to or less than one-half of the thickness t of the gas storage module 100.

Moreover, each channel 116 is formed into the thickness of the first surface 106 or second surface 108 and is separated from the opposite surface by a separation distance along the thickness direction. This separation distance is thus less than the overall thickness t of the gas storage module 100. As noted above, gas diffuses from the channels 116 into the packing of a given gas storage module in the directions depicted by the arrows 120 in FIG. 1. Also, when multiple gas storage modules are stacked closely together, gas diffuses from the channels of a given gas storage module into the packing of the adjacent gas storage module(s) in directions opposite to these arrows 120. Hence, the maximum gas diffusion length in the thickness direction may be represented approximately by the arrows 120, and may be less than one half of the thickness t of the gas storage module 100.

As further illustrated in FIG. 1, the gas storage module 100 may also include a heat exchanging structure 130. The heat exchanging structure 130 may have any configuration suitable for carrying out heat transfer (heat removal and addition at appropriate times) throughout the body 104, particularly in a manner that optimizes the adsorption and desorption processes. The heat exchanging structure 130 may include one or more components such as, for example, one or more conduits 132 for directing the flow of a heat exchanging medium into thermal contact with the body 104. The heat exchanging structure 130 (or a portion or component of the heat exchanging structure 130) may extend in one or more directions along the plane that is co-planar with the first surface 106 and second surface 108. The heat exchanging structure 130 may include an internal component located in the body 104 (i.e., between the first surface 106 and second surface 108), and/or an external component located outside the body 104 and adjacent to the first surface 106 and/or the second surface 108.

In the embodiment illustrated in FIG. 1, the heat exchanging structure 130 includes a conduit 132 extending through the bulk (or thickness) of the body 104. The conduit 132 includes opposing ends 134 and 136 to provide an inlet and an outlet for the heat exchanging medium. The conduit 132 may be configured to provide a flow path that spans a large portion of the cross-section to ensure good thermal contact between the heat transfer medium and the entire volume of the body 104. For this purpose, the conduit 132 may include one or more bends to provide a multi-turn flow path. In the illustrated embodiment, the conduit 132 is S-shaped or Z-shaped. In other embodiments, the conduit 132 may be serpentine, wave-shaped, etc. The conduit 132 may be disposed at or near the center elevation of the thickness t of the body 104 so as to be equidistant or substantially equidistant from the first surface 106 and the second surface 108. Because the thickness t is relatively small, this configuration minimizes the thermal conduction length in the thickness direction. It can be seen that in some embodiments the maximum thermal conduction length from the conduit 132 toward either the first surface 106 or second surface 108 is less than one-half of the thickness t.

In the present embodiment, the heat exchanging structure 130 also includes chambers or plenum sections 144 and 146 positioned in fluid communication with the respective ends 134 and 136 of the conduit. The axis of each plenum section 144 and 146 is typically oriented in the direction orthogonal to the cross-section of the gas storage module 100. Each plenum section 144 and 146 extends between, and opens at, the first surface 106 and second surface 108. The plenum sections 144 and 146 may be utilized to feed the heat exchanging medium into the conduit's inlet or collect the heat exchanging medium from the conduit's outlet. Multiple gas storage modules may be stacked together (FIGS. 4 and 5) such that their respective plenum sections are aligned, thereby forming plenums that extend through the entire elevation of the stack.

The conduit 132 and plenum sections 144 and 146 may be composed of a material having high thermal conductivity, such as various metals (e.g., copper). In some embodiments, additional conduits and plenum sections may be provided. In other embodiments internal plenum sections 144 and 146 are not provided, and instead the ends 134 and 136 of the conduit 132 open at the side wall 110 in fluid communication with external plenums.

The heat exchanging medium may be any fluid capable of transferring heat at a rate that enhances the adsorption/desorption process in a given embodiment of the gas storage module 100. In some embodiments, the medium is a liquid such as water or glycol. In other embodiments, the medium is a gas such as air.

In operation, the heat exchanging structure 130 is utilized to remove heat from the gas storage module 100 during charging (adsorption), and is subsequently utilized to add heat to the gas storage module 100 during discharging (desorption). The heat exchanging structure 130 circulates the heat transfer medium at an initial temperature and flow rate selected to optimize the adsorption or desorption process. The parameters of the heat transfer medium such as initial temperature and flow rate may depend on several factors associated with a given embodiment such as, for example, the type of adsorbent, the type of gas, the size of the gas storage module 100, and the size and configuration of the heat exchanging structure 130.

Other embodiments may include other types of heat exchanging structures in addition to, or as an alternative to, a conduit or conduits. These other types of heat exchanging structures may be internal or external to the packing Examples include, but are not limited to, fins, meshes, sheets (plates), foam sheets, corrugated sheets, perforated sheets, and combinations of two or more of the foregoing. In other embodiments, the heat exchanging structure may include active devices that do not circulate a heat transfer medium, such as thermoelectric devices (e.g., Peltier devices), electrically resistive devices, etc.

From the foregoing, it is evident that maximum gas diffusion lengths and/or thermal conduction lengths may be less than one-half of the thickness t of the gas storage module 100. As such, one or more embodiments disclosed herein may mitigate the mass transfer and heat transfer limitations created by long diffusion/conduction lengths imposed by prior adsorptive gas storage approaches.

FIG. 4 is a perspective view of an example of a gas storage apparatus 400 according to some embodiments. FIG. 5 is an elevation view of the gas storage apparatus 400, on a side where ends of gas flow channels 116 are located. The gas storage apparatus 400 includes a plurality of gas storage modules 100 stacked together. The gas storage modules 100 are stacked such that the first surface 106 or second surface 108 of each gas storage module 100 faces the first surface 106 or second surface 108 of at least one other adjacent gas storage module. This stacked configuration is facilitated by the low-profile geometry of the gas storage modules 100, as noted above. Many gas storage modules 100 may be stacked together to provide a large energy storage capacity while occupying a comparatively minimal amount of volume. The short gas diffusion and thermal conduction lengths provided by the individual gas storage modules 100 are repeated throughout the entire stack. The aligned plenum sections 144 and 146 of the gas storage modules 100 result in plenums 444 and 446 useful for circulating the heat transfer medium through multiple layers of the stack. It will be understood that FIGS. 4 and 5 illustrate the gas storage modules 100 in a vertically stacked orientation by example only. No limitation is placed on the orientation of the stack. For example, the gas storage modules 100 may be stacked in a horizontal orientation.

In some embodiments, there is no spacing between adjacent gas storage modules 100 other than the flow channels 116 utilized for distributing gas to and from the adsorbent, as illustrated by example in FIGS. 4 and 5. In other embodiments, damping components (e.g., resilient spacers such as gaskets) may be provided between adjacent gas storage modules 100 to minimize the transfer of vibration to the gas storage modules 100 and/or collision between adjacent gas storage modules 100.

In some embodiments, each gas storage module 100 or the entire stack may be encased in a natural or synthetic fiber mesh, which may be useful for reducing interaction between the gas storage modules 100 and the inside surface of the tank. The mesh utilized may be one that exhibits high gas flux and does not inhibit gas uptake to or release from the gas storage modules 100.

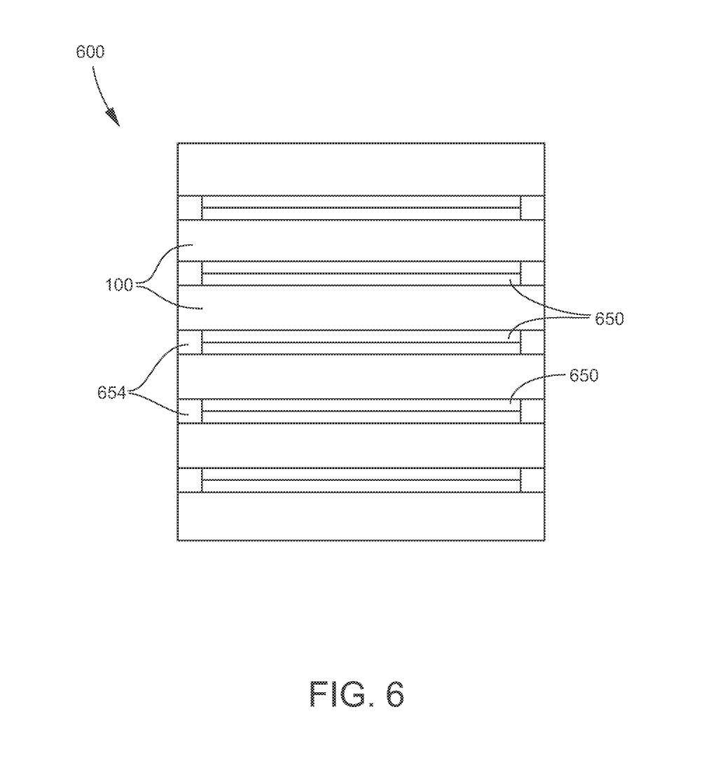

FIG. 6 is an elevation view of an example of a gas storage apparatus 600 according to other embodiments. The gas storage apparatus 600 includes external heat exchanging structures 650 intercalated between adjacent gas storage modules 100. The external heat exchanging structures 650 may be generally two-dimensional or planar. Examples of external heat exchanging structures 650 include, but are not limited to, meshes (grids), sheets (plates), foam sheets, corrugated sheets, perforated sheets, and combinations of two or more of the foregoing. The external heat exchanging structures 650 may be provided additionally or alternatively to internal (embedded) heat exchanging structures. FIG. 6 also shows damping components 654 positioned between adjacent gas storage modules 100 according to some embodiments.

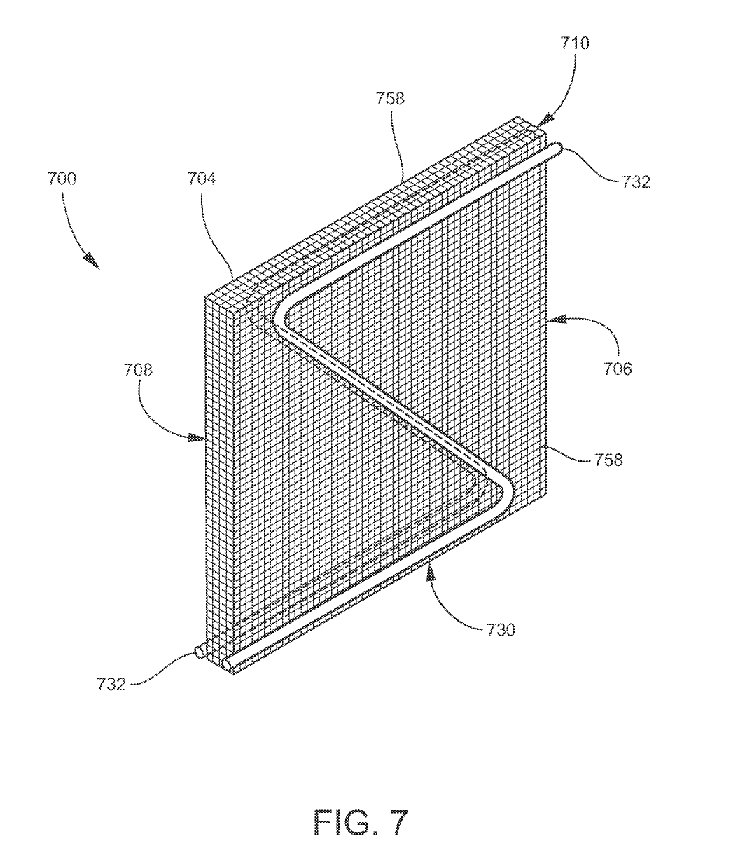

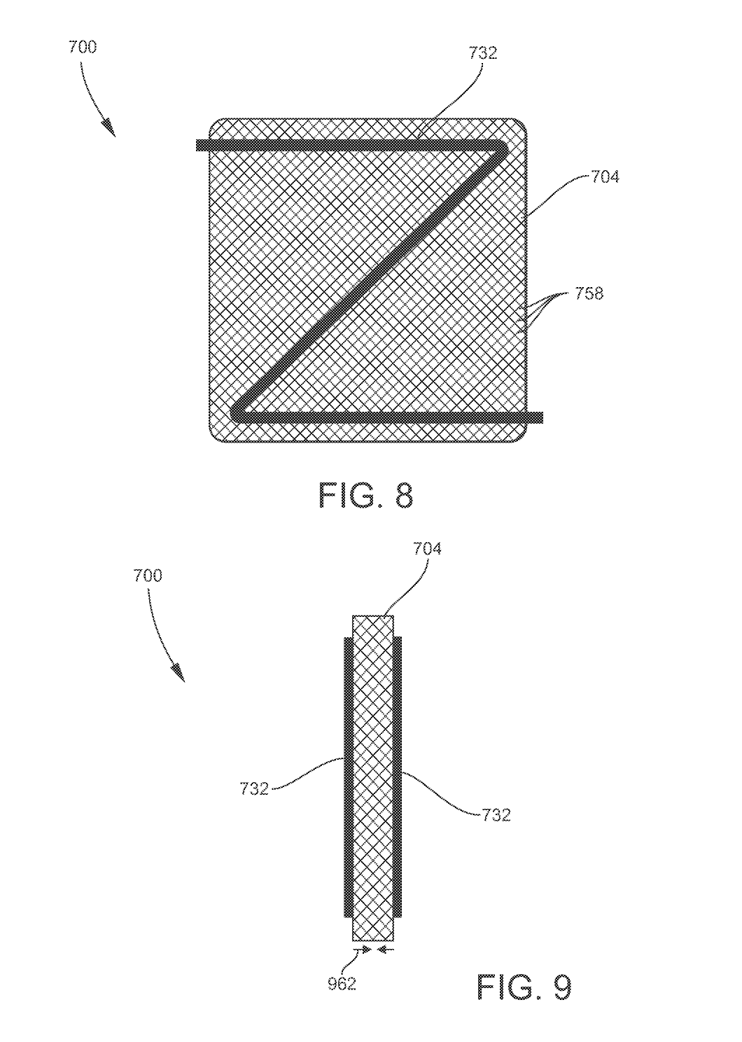

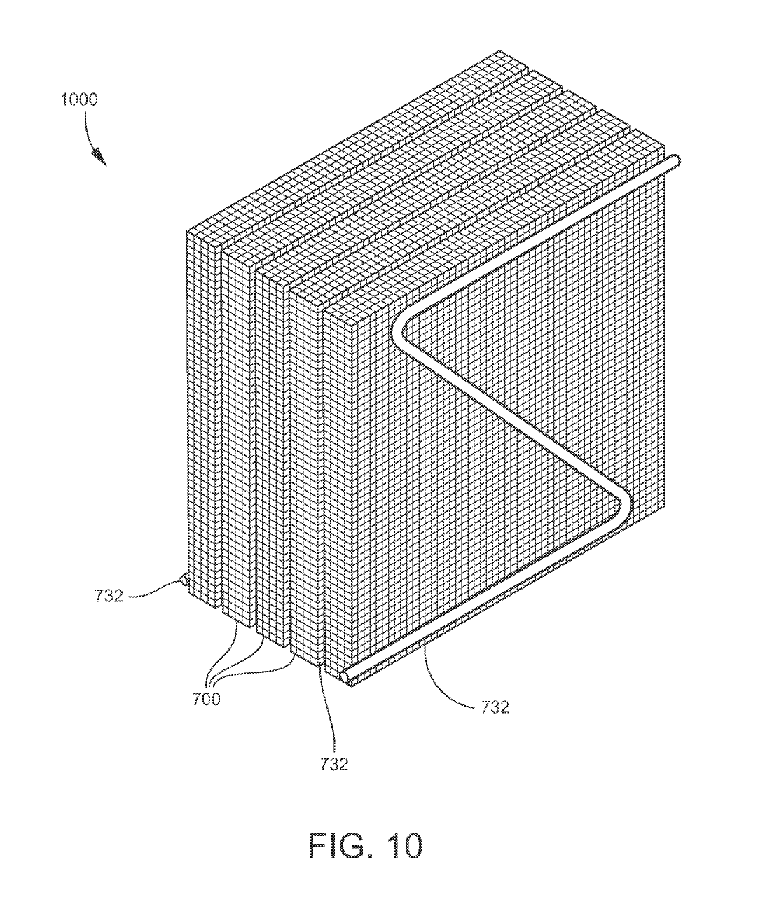

FIGS. 7-9 illustrate an example of a gas storage module 700 according to other embodiments. Specifically, FIG. 7 is a perspective view, FIG. 8 is a plan view, and FIG. 9 is a side view of the gas storage module 700. The gas storage module 700 may generally include a two-dimensional or planar body 704 and a porous support structure 758. The body 704 includes a first surface 706, an opposing second surface 708, and a side wall 710 between the first surface 706 and second surface 708. The support structure 758 may encapsulate the entire body 704. That is, the support structure 758 may include a plurality of sides or sections adjacent to, and in contact with, the corresponding outer surfaces (first surface 706, second surface 708, and side wall sections) of the body 704. Similar to the gas storage module 100 described above and illustrated in FIGS. 1-4, the gas storage module 700 of the present embodiment has a low-profile geometry that facilitates stacking several gas storage modules together, as described below in conjunction with FIG. 10. Additionally, the rectilinear cross-section shown in FIGS. 7-9 is but one example; other geometries may be provided as noted earlier in this disclosure.

The body 704 is formed as a packing of porous, adsorbent particles. Generally, the composition and porosity of the adsorbent particles may be as described earlier in this disclosure. In this embodiment, the adsorbent particles may be particles (or extrudates) that are individually robust and self-supporting, but they may be less tightly packed together in comparison to the overall self-supporting module described above in conjunction with FIGS. 1-3. Hence, in the present embodiment the size of the particles and interstitial spacing between the particles may be comparatively greater. The comparatively larger particles may be formed by, for example, extrusion or spray drying. In some embodiments, the larger particles may be formed by binding smaller particles together to form larger particles according to any method now known or later developed. Each individual large particle may include only adsorbent material, or may include a mixture of adsorbent material and binders, or may further include additives as described above.

In other embodiments, the size of the adsorbent particles may be similar to that of the self-supporting module of FIGS. 1-3, but more loosely packed in comparison thereto.

The support structure 758 may be composed of a thermally conductive material, such as various metals. The support structure material is self-supporting (e.g., rigid) to provide a stable form to the bed of packed particles (i.e., the body 704). The support structure 758 may have any highly porous configuration—that is, the support structure 758 includes a plurality of openings, or pores—such that the support structure 758 provides multiple gas pathways into and out from the body 704. Examples include, but are not limited to, meshes (or grids, or screens), foams, perforated sheets, porous sheets, etc. As indicated above, the provision of the support structure 758 allows the particle bed in this embodiment to be more loosely packed in comparison to the more monolithic body of the self-supporting module of FIGS. 1-3. Consequently, the particle bed of the present embodiment may be subjected to less physical stresses.

The encapsulated gas storage module 700 includes a plurality of gas flow channels communicating with exposed outside surfaces of the gas storage module 700. The intraparticle voids dispersed throughout the bulk of the body 704 define multiple paths promoting the free flow of gas. Thus, in this embodiment the flow channels may be characterized as including a network of paths running through interstices of the body 704. Many of these paths are in fluid communication with the openings or pores of the support structure 758, thereby completing gas access routes between the environment outside of the body 704 (e.g., a tank interior) and the adsorption sites within the body 704.

Due to the confined configuration of the encapsulated gas storage module 700, traditional problems such as particle attrition, settling, and segregation may be mitigated. In some embodiments if needed or desired, the body 704 may be encased in a highly porous fabric sheet or mesh, i.e., the sheet or mesh would be between the body 704 and the support structure 758. The sheet or mesh may function to assist in retaining the packed particles in a stable modular form, and/or or reducing or elimination the elution of particle fines into the tank interior.

As further illustrated in FIGS. 7-9, the gas storage module 700 may also include a heat exchanging structure 730. The heat exchanging structure 730 generally may have various configurations and components such as described above. In the example specifically illustrated, the heat exchanging structure 730 includes two conduits 732 located adjacent to the first surface 706 and second surface 708, respectively. The ends of the conduits 732 may be placed in fluid communication with plenums external to the body 704. The plenums may be integral with or mounted to the support structure 758, or may be provided separately in a tank. Alternatively or additionally, the heat exchanging structure 730 may include components that do not conduct a heat transfer medium, such as sheets, fins, thermoelectric elements, etc. In the illustrated embodiment, the heat exchanging structure 730 is integral with or mounted to the support structure 758, and is positioned on external sides of the support structure 758. Alternatively or additionally, the heat exchanging structure 730 may be positioned on internal sides of the support structure 758. As a further alternative or addition, all or part of the heat exchanging structure 730 may be located in the bulk of the body 704 as in the case of the embodiment of FIGS. 1-6.

Similar to the embodiment of FIGS. 1-6, the encapsulated gas storage module 700 essentially has a 2-dimensional structure that minimizes gas diffusion and thermal conduction limitations attending prior adsorptive gas storage approaches. Gas is free to move through the many paths provided through the bulk of the particle mass comprising the body 704 of the gas storage module 700, such that gas diffusion lengths may be well below one-half of the thickness of the gas storage module 700. Encapsulating the gas storage module 700 in a porous, mesh-like structure allows for the free movement of gas in to and out from the gas storage module 700 with very little resistance. Because each surface of the gas storage module 700 can be exposed to the flowing gas and the gas storage module 700 is very narrow in thickness, all particles within the gas storage module 700 will be exposed to essentially the same gas concentration and pressure. Even with components of the heat exchanging structure 730 positioned on the external surfaces, the maximum heat conduction length remains at or about one-half of the thickness of the gas storage module 700, as represented by arrows 962 in FIG. 9.

FIG. 10 is a perspective view of an example of a gas storage apparatus 1000 according to some embodiments. The gas storage apparatus 1000 includes a plurality of gas storage modules 700 stacked together. The gas storage modules 700 are stacked such that the first surface 706 or second surface 708 of each gas storage module 700 faces the first surface 706 or second surface 708 of at least one other adjacent gas storage module 700. As in the case of the gas storage apparatuses 400 and 600 described above and illustrated in FIGS. 4-6, the short gas diffusion and thermal conduction lengths provided by the individual gas storage modules 700 are repeated throughout the entire stack. In the present embodiment, the provision of external heat exchanging components 732 provides spacing between adjacent gas storage modules 700. In other embodiments, damping materials (e.g., resilient spacers such as gaskets) may be provided between adjacent gas storage modules 700 to minimize the transfer of vibration to the gas storage modules 700 and/or collision between adjacent gas storage modules 700.

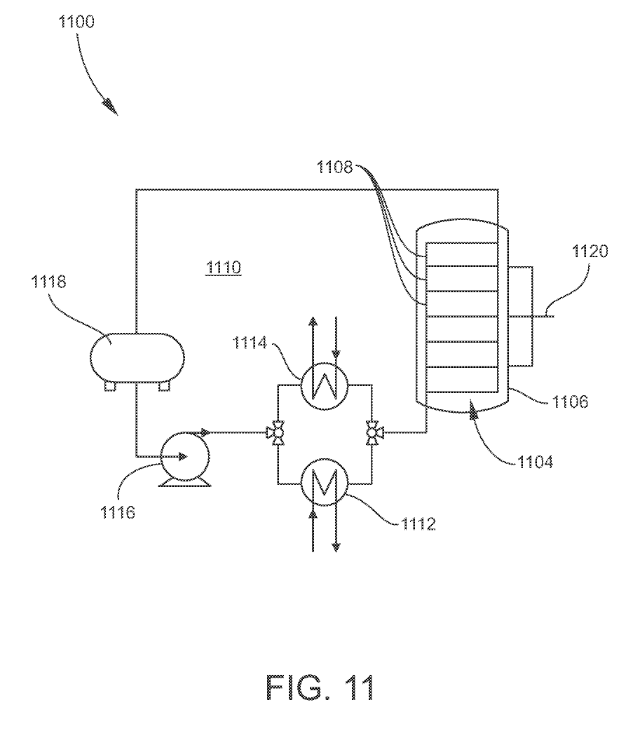

FIG. 11 is a schematic view of an example of a gas storage system 1100 according to some embodiments. The gas storage system 1100 may be located in any suitable operating environment in which gas is to be received for storage and/or supplied for use by a power consuming device. The operating environment may be a stationary or fixed installation such as a fuel storage/supply site, or may be a movable or portable installation such as a vehicle or portable device.

The gas storage system 1100 may include a gas storage apparatus 1104 positioned in a tank 1106. The tank 1106 may be any suitable pressure vessel rated for the pressure ranges contemplated by the present disclosure. The internal gas pressure may range, for example, from 1 to 200 bar. In some embodiments, the internal gas pressure ranges from 1 to 40 bar. The gas storage apparatus 1104 includes a plurality of gas storage modules 1108 stacked together as described above. The gas storage modules 1108 may be self-supporting modules (engineered modules) or encapsulated modules, and may include integrated features such as gas flow channels and heat exchanging structures, according to any of the embodiments disclosed herein. The gas storage apparatus 1104 may be mounted in the tank 1106 by any suitable means, using support members, vibration dampers, etc. as appreciated by persons skilled in the art. As described earlier in this disclosure, the cross-section of the gas storage modules 1108 may be shaped such that the gas storage apparatus 1104 may be mounted in close proximity to at least a portion of the inside wall of the tank 1106. In some embodiments, the gas storage apparatus 1104 is configured such that the adsorbent has a specific packing volume in the tank 1106 ranging from 0.2 to 1.0 mLₛ/mLₜₐₙₖ.

The gas storage system 1100 may include a heat exchanging system 1110 for adding heat to or removing heat from the gas storage modules 1108 as needed, such as by circulating a heat transfer medium in a controlled manner. The heat exchanging system 1110 is schematically representative of any number of heat exchanging components that may be provided for the purpose of circulating a heated or cooled heat transfer medium to and from the tank 1106. Some of all of the heat exchanging components may be located external to the tank 1106. The heat transfer medium may be routed to and from the tank interior via fluid lines passing through sealed ports or feed-throughs in the tank wall. The heat exchanging system 1110 may, for example, include a heater 1112, a cooler 1114, a pump 1116, an accumulation vessel or reservoir 1118, etc. More generally, as appreciated by persons skilled in the art, the heat exchanging system 1110 may include heat sources, heat sinks, heat pipes, boilers, evaporators, condensers, pumps, valves, etc. as needed or desired for a particular implementation. The heat exchanging system 1110 may share one or more components with an existing heating/cooling system such as, for example, an automobile's air conditioning system or engine cooling system.

The gas storage system 1100 may further include one or more gas lines 1120 passing through one or more sealed ports in the tank wall. Gas to be stored by the gas storage apparatus 1104 may be supplied from an external gas source to the tank 1106 via the gas line(s) 1120. Gas to be distributed may be flowed from the tank 1106 to a receptacle, power consuming device or other destination via gas line(s) 1120. The gas flow in either case may be assisted by pumps or other types of fluid moving devices, and may be controlled by flow regulators such as mass flow or pressure regulators.

It may be appreciated from the foregoing description that gas storage modules according to embodiments described herein may provide one or more advantages. The gas storage modules may be implemented in an adsorbed gas storage tank. Modularizing the adsorbent bed enables intimate integration of heat transfer elements and provides open-cells for the free movement of gas in the tank. Modularization enables the creation of a multitude of parallel beds that operate uniformly, in contrast to randomly packed beds or beds in series which experience significant temperature, pressure, and concentration gradients causing unstable operation and additional control challenges. The gas storage modules may increase the VED of the tank by densifying the adsorbent and increasing the specific packing volume. The gas storage modules may effectively integrate an internal heat management system capable of meeting both heating and cooling loads, thus enabling rapid charge and discharge rates and increasing the effective, working capacity of the adsorbent (VED). The gas storage modules may efficiently distribute gas within the tank to promote rapid charging and discharging while minimizing resistance to gas flow.

In general, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

1. A gas storage module, comprising:
a two-dimensional body comprising a first surface, an opposing second surface, a side wall between the first surface and the second surface, and a plurality of channels communicating with the side wall and extending from the side wall through or along the body; and
a heat exchanging structure extending along a plane co-planar with the first surface and the second surface,
wherein the body comprises a packed mixture of an adsorbent and a binder, the adsorbent comprising a plurality of particles having a composition and porosity effective for adsorbing a gas, and the binder having a composition effective for binding the particles together.

2. The gas storage module of claim 1, wherein the body is packed so as to be self-supporting, at least one of the first surface and the second surface comprises the channels such that the channels extend along the at least one surface, and the channels are open in a direction away from the body.

3. The gas storage module of claim 2, wherein the plurality of channels has a configuration comprising at least one of:
each channel is separated from an adjacent channel by a separation distance, and one-half of the separation distance is equal to or less than one-half of a thickness of the side wall;
each channel comprises an inlet communicating with a first section of the side wall, and an outlet communicating with a different section of the side wall located at a different side of the body than the first section;
the plurality of channels comprises a plurality of first channels extending along the first surface and a plurality of second channels extending along the second surface.

4. (canceled)

5. The gas storage module of claim 2, wherein the heat exchanging structure has a configuration comprising at least one of:
the heat exchanging structure extends through a thickness of the body between the first surface and the second surface;
the heat exchanging structure comprises a conduit embedded within the body;
the heat exchanging structure comprises an inlet and an outlet, and the body comprises a first plenum section extending through the thickness and communicating with the inlet, and a second plenum section extending through the thickness and communicating with the outlet.

6.-8. (canceled)

9. The gas storage module of claim 1, comprising a porous support structure encapsulating the body and composed of a thermally conductive material, wherein the plurality of channels comprises a network of paths running through interstices of the body and communicating with one or more pores of the support structure, and the heat exchanging structure is adjoined to a side of the support structure facing toward or away from the body.

10. The gas storage module of claim 9, wherein the heat exchanging structure comprises a first heat exchanging element adjoined to a first side of the support structure adjacent to the first surface, and a second heat exchanging element adjoined to a second side of the support structure adjacent to the second surface.

11. (canceled)

12. The gas storage module of claim 1, wherein the binder is selected from the group consisting of clays, aluminas, silicas, polymers, and a combination of two or more of the foregoing.

13. The gas storage module of claim 1, comprising a flexible, porous material encasing the body.

14. The gas storage module of claim 1, wherein the heat exchanging structure comprises a two-dimensional structure embedded in the body, or adjacent to at least one of the first surface and the second surface.

15. The gas storage module of claim 14, wherein the two-dimensional structure is selected from the group consisting of a mesh, a corrugated sheet, a perforated sheet, a foam sheet, and a combination of two or more of the foregoing.

16. The gas storage module of claim 1, wherein the adsorbent is selected from the group consisting of:
activated carbon;
metal organic frameworks;
zeolites;
porous polymers;
an adsorbent effective for adsorbing natural gas;
an adsorbent effective for adsorbing methane;
an adsorbent effective for adsorbing gaseous hydrocarbons;
an adsorbent effective for adsorbing hydrogen;
an adsorbent effective for adsorbing carbon dioxide;
an adsorbent effective for adsorbing ammonia;
an adsorbent effective for adsorbing gaseous fluorocarbon-based compounds;
an adsorbent having a gravimetric loading capacity for methane of 0.2 or greater g_{CH4}/gₛ;
an adsorbent having a bulk density ranging from 0.2 to 1.5 gₛ/mLₛ; and
a combination or two or more of the foregoing.

17.-19. (canceled)

20. A gas storage apparatus, comprising a plurality of the gas storage modules of claim 1, the gas storage modules stacked together such that the first surface or the second surface of each gas storage module faces the first surface or second surface of at least one other adjacent gas storage module.

21. The gas storage apparatus of claim 20, wherein:
for each gas storage module, the heat exchanging structure comprises a conduit embedded in the body;
for each gas storage module, the body comprises a first plenum section extending through the thickness and communicating with an inlet of the heat exchanging structure, and a second plenum section extending through the thickness and communicating with an outlet of the heat exchanging structure; and
the first plenum sections collectively form a first plenum and the second plenum sections collectively form a second plenum.

22.-23. (canceled)

24. The gas storage apparatus of claim 20, comprising a tank enclosing a tank interior, wherein the gas storage modules are disposed in the tank interior and the channels communicate with the tank interior, and the tank comprises a port configured for selectively providing communication between the tank interior and a location external to the tank.

25. (canceled)

26. The gas storage apparatus of claim 24, wherein the adsorbent has a specific packing volume in the tank ranging from 0.2 to 1.0 mLₛ/mLₜₐₙₖ.

27. A method for fabricating a gas storage module, the method comprising:
mixing an adsorbent and a binder, wherein the adsorbent comprises a plurality of particles having a composition and porosity effective for adsorbing a gas, and the binder having a composition effective for binding the particles together;
forming a two-dimensional body from the mixture such that the body comprises a first surface, an opposing second surface, a side wall between the first surface and the second surface, and a plurality of channels communicating with the side wall and extending from the side wall through or along the body, wherein forming comprises packing the mixture to a desired density of the adsorbent in the body; and
positioning a heat exchanging structure relative to the body such that the heat exchanging structure extends along a plane co-planar with the first surface and the second surface.

28. The method of claim 27, wherein forming the body comprises at least one of:
pressing the mixture using a mold, or extruding the mixture through a die;
packing the mixture such that the body is self-supporting;
forming the channels on at least one of the first surface and the second surface such that the channels are open in a direction away from the body;
encapsulating the mixture in a porous support structure such that the plurality of channels comprises a network of paths running through interstices of the body and communicating with one or more pores of the support structure.

29.-30. (canceled)

31. The method of claim 27, wherein positioning the heat exchanging structure comprises at least one of:
packing the mixture around the heat exchanging structure, wherein the heat exchanging structure is embedded in the body;
adjoining the heat exchanging structure to a side of the support structure facing toward or away from the body.

32.-33. (canceled)

34. A method for fabricating a gas storage apparatus, the method comprising: stacking together a plurality of the gas storage modules of claim 1, such that the first surface or the second surface of each gas storage module faces the first surface or second surface of at least one other adjacent gas storage module.

35. The method of claim 34, comprising fabricating the gas storage modules according to the method of claim 27.

36.-38. (canceled)

39. A method for storing gas, the method comprising:
flowing the gas through a plurality of channels extending through or along a two-dimensional body comprising a plurality of adsorbent particles, wherein the gas diffuses into the body from the channels and is adsorbed in pores of the particles, and the adsorption generates heat; and
while flowing the gas, transferring the heat from the adsorbent particles to a heat exchanging structure extending along a plane co-planar with a first surface and an opposing second surface of the body.

40. The method of claim 39, wherein the body comprises a side wall between a first surface and an opposing second surface of the body, and flowing the gas comprises flowing the gas through inlets of the channels located at the side wall.

41. The method of claim 39, wherein the body is encapsulated in a porous support structure, and the plurality of channels comprises a network of paths running through interstices of the body and communicating with one or more pores of the support structure, and flowing the gas comprises flowing the gas through one or more of the pores.

42.-43. (canceled)

44. The method of claim 39, wherein the body is one of a plurality of bodies stacked together, and the gas is flowed through a plurality of channels of each body.

45.-46. (canceled)

47. The gas storage apparatus of claim 20, wherein for each gas storage module, the body is packed so as to be self-supporting, at least one of the first surface and the second surface comprises the channels such that the channels extend along the at least one surface, and the channels are open in a direction away from the body.

48. The gas storage apparatus of claim 20, wherein each gas storage module comprises a porous support structure encapsulating the body and composed of a thermally conductive material, wherein the plurality of channels comprises a network of paths running through interstices of the body and communicating with one or more pores of the support structure, and the heat exchanging structure is adjoined to a side of the support structure facing toward or away from the body.
